(19) United States
(12) Patent Application Publication
(10) Pub. No.: US 2021/0231964 A1
(43) Pub. Date: Jul. 29, 2021

(54) LIGHT SOURCE DEVICE, PROJECTION DEVICE USING SAME, AND FLUORESCENCE EXCITATION DEVICE

(71) Applicant: Panasonic Intellectual Property Management Co., Ltd., Osaka (JP)

(72) Inventors: RYO HASEYAMA, Osaka (JP); TOMOYA SUGITA, Nara (JP)

(21) Appl. No.: 17/267,340

(22) PCT Filed: Aug. 23, 2019
(86) PCT No.: PCT/JP2019/032942

§ 371 Date: Feb. 9, 2021

(30) Foreign Application Priority Data
Oct. 5, 2018 (JP) 2018-189666

(51) Int. Cl. G02B 27/09; G02B 19/00; G02B 26/10; F21V 9/30

(52) U.S. Cl. CPC G02B 27/0916; G02B 19/0052; G02B 27/0966; F21V 9/30; G02B 26/10

(57) ABSTRACT

In a light source device, and a projection device and a fluorescence excitation device using the same, a light beam emitted from a semiconductor laser is focused at a prescribed focusing position after an aspect ratio of the light beam has been adjusted, by which a spot diameter at the focusing position is reduced. Light source device includes: semiconductor laser; beam shaping lens that adjusts an aspect ratio of light beam emitted from semiconductor laser; and condenser lens that focuses light beam passing through beam shaping lens on prescribed focusing position, wherein beam shaping lens is a cylindrical lens having negative power with respect to a slow axis direction of incident light beam.

### TECHNICAL FIELD

The present disclosure relates to a light source device that adjusts an aspect ratio of a light beam emitted from a semiconductor laser and then focuses the light beam at a prescribed focusing position, and a projection device and a fluorescence excitation device using the same.

### BACKGROUND ART

A conventional light source using a semiconductor laser requires a beam shaping optical system for adjusting an aspect ratio of an elliptical luminous flux and a collimating lens for converting divergent light into parallel light. As the beam shaping optical system, an optical system having a combination of two cylindrical lenses or an optical system using a lens that has toric surfaces on both sides are known. The beam shaping optical systems described above perform optical processing on light beams emitted from the semiconductor laser for increasing a divergence angle along a slow axis and decreasing a divergence angle along a fast axis.

It should be noted that, for example, PTL 1 and PTL 2 are known as prior art documents containing information related to this disclosure.

### CITATION LIST

### Patent Literature

PTL 1: Unexamined Japanese Patent Publication No. 2002-323673
PTL 2: Unexamined Japanese Patent Publication No. S52-24542

### SUMMARY OF THE INVENTION

However, when the abovementioned optical processing is performed by the beam shaping optical system, a luminous flux diameter along the fast axis of the light beam is reduced by the optical processing. The decrease in the luminous flux diameter leads to a problem that a spot diameter at a focusing position of the light source device increases.

In view of this, an object of the present disclosure is to address the problem described above and to reduce a spot diameter at a focusing position of the light source device.

A light source device according to one aspect of the present disclosure includes: a semiconductor laser; a beam shaping lens that adjusts an aspect ratio of a light beam emitted from the semiconductor laser and transmits the light beam; and a condenser lens that focuses the light beam passing through the beam shaping lens at a focusing position. The beam shaping lens is a cylindrical lens having negative power with respect to a slow axis direction of the incident light beam.

A projection device according to one aspect of the present disclosure includes: a light source device; and an optical scanning mirror disposed at a focusing position of the light source device. The light source device includes: a semiconductor laser; a beam shaping lens that adjusts an aspect ratio of a light beam emitted from the semiconductor laser; and a condenser lens that focuses the light beam exiting from the beam shaping lens at the focusing position. The beam shaping lens is a cylindrical lens having negative power with respect to a slow axis direction of the incident light beam.

A fluorescence excitation device according to one aspect of the present disclosure includes: a light source device; and a phosphor disposed at a focusing position of the light source device. The light source device includes: a semiconductor laser; a beam shaping lens that adjusts an aspect ratio of a light beam emitted from the semiconductor laser; and a condenser lens that focuses the light beam exiting from the beam shaping lens at the focusing position. The beam shaping lens is a cylindrical lens having negative power with respect to a slow axis direction of the incident light beam.

With this configuration, the present disclosure can reduce a spot diameter at the focusing position.

### BRIEF DESCRIPTION OF DRAWINGS

FIG. 1A is a diagram schematically showing a light source device according to the present disclosure as viewed from a slow axis.

FIG. 1B is a diagram schematically showing the light source device according to the present disclosure as viewed from a fast axis.

FIG. 2 is a perspective view of a beam shaping lens used in the light source device according to the present disclosure.

FIG. 3 is a top view of the beam shaping lens used in the light source device according to the present disclosure as viewed from a positive direction of the fast axis.

FIG. 4 is a perspective view showing a disposition of a light source and the beam shaping lens used in the light source device according to the present disclosure.

FIG. 5 is a diagram showing a relationship between a numerical aperture and a spot diameter.

FIG. 6A is a diagram schematically showing a method for adjusting a focusing position of the light source device according to the present disclosure as viewed from the slow axis.

FIG. 6B is a diagram schematically showing the method for adjusting the focusing position of the light source device according to the present disclosure as viewed from the fast axis.

FIG. 7 is a schematic diagram showing a projection device according to the present disclosure.

FIG. 8 is a schematic diagram showing a fluorescence excitation device according to the present disclosure.

FIG. 9 is a diagram schematically showing an example of a vehicle-mounted head-up display according to the present disclosure.

FIG. 10 is a schematic diagram of the vehicle-mounted head-up display according to the present disclosure.

FIG. 11 is a diagram schematically showing how an image is displayed in the vehicle-mounted head-up display according to the present disclosure.

FIG. 12A is a top view of a beam shaping lens according to modification A of the light source device according to the present disclosure as viewed from the positive direction of the fast axis.

FIG. 12B is a top view of a beam shaping lens according to modification B of the light source device according to the present disclosure as viewed from the positive direction of the fast axis.

FIG. 12C is a top view of a beam shaping lens according to modification C of the light source device according to the present disclosure as viewed from the positive direction of the fast axis.

FIG. 12D is a top view of a beam shaping lens according to modification D of the light source device according to the present disclosure as viewed from the positive direction of the fast axis.

FIG. 12E is a top view of a beam shaping lens according to modification E of the light source device according to the present disclosure as viewed from the positive direction of the fast axis.

### DESCRIPTION OF EMBODIMENT

A light source device according to an exemplary embodiment of the present disclosure will be described below with reference to the drawings. It should be noted that the exemplary embodiment described below provides a preferred specific example of the present disclosure. Therefore, shapes, constituent elements, arrangement and connection modes of the constituent elements, etc. described in the following exemplary embodiment are merely examples, and are not intended to limit the present disclosure. Thus, among the constituent elements in the following exemplary embodiment, the constituent elements not recited in the independent claim indicating the broadest concept of the present invention are described as optional constituent elements.

It should also be noted that each of the diagrams is schematic, and is not necessarily strictly accurate. Throughout the drawings, the same or equivalent components will be denoted by the same reference marks, and redundant description will be omitted or simplified.

### (Configuration of Light Source Device)

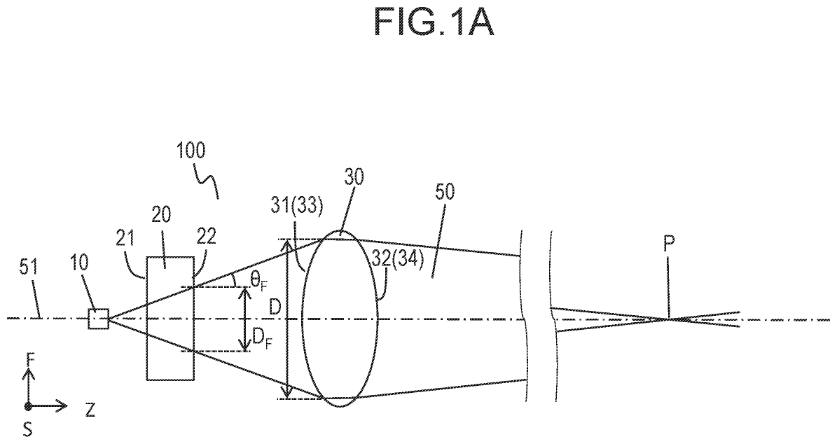

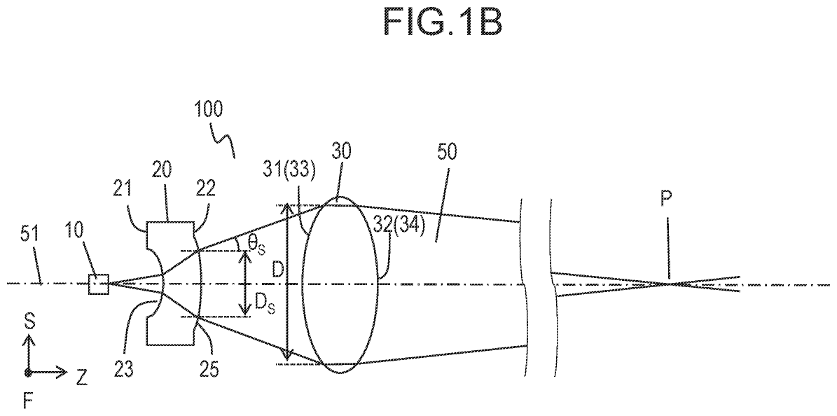

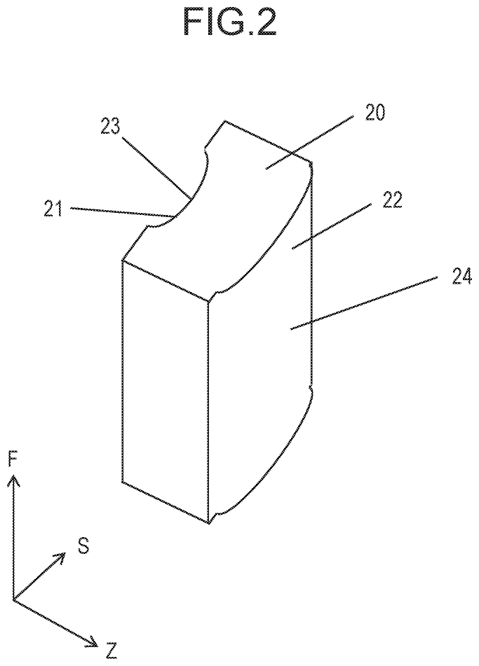

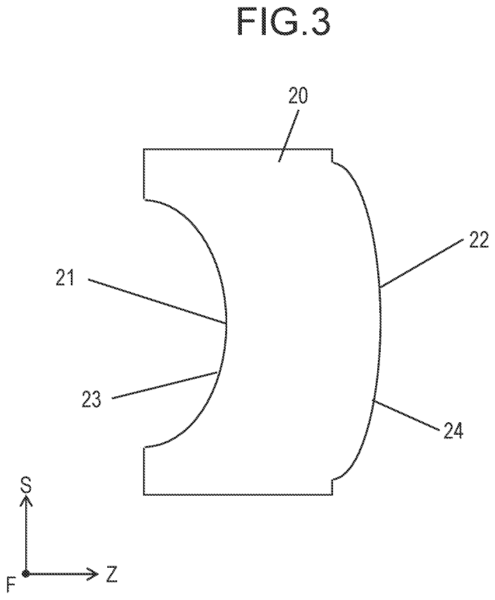

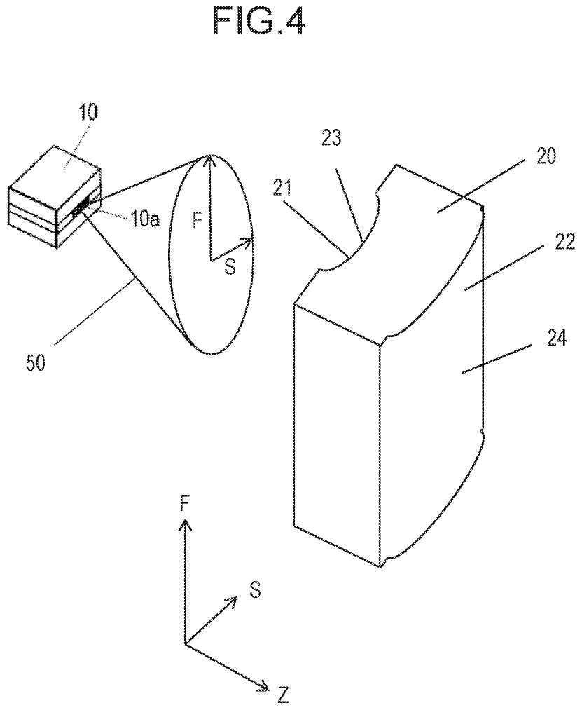

A light source device according to one aspect of the present disclosure will be described below with reference to the drawings. FIGS. 1A and 1B are diagrams schematically showing a configuration of a main part of light source device 100. FIG. 1A is a diagram of light source device 100 as viewed from slow axis S. FIG. 1B is a diagram of light source device 100 as viewed from fast axis F. Further, FIG. 2 is a perspective view of beam shaping lens 20 used in light source device 100. FIG. 3 is a top view of beam shaping lens 20 shown in FIG. 2 as viewed from a positive direction of fast axis F. FIG. 4 is a perspective view showing a disposition relationship between semiconductor laser 10 and beam shaping lens 20 which are used in light source device 100. FIG. 5 is a perspective view showing a beam shape of light beam 50 after passing through beam shaping lens 20.

As shown in FIGS. 1A and 1B, light source device 100 includes semiconductor laser 10, beam shaping lens 20, and condenser lens 30. A cross section of light beam 50 emitted from semiconductor laser 10 cut along a plane perpendicular to optical axis 51 has an elliptical shape as shown in FIG. 4. As shown in FIG. 4, a major axis of the ellipse is fast axis F of semiconductor laser 10. Fast axis F is parallel to a cleavage plane of semiconductor laser 10 and coincides with a thickness direction of active layer 10a of semiconductor laser 10. A minor axis of the ellipse is slow axis S of semiconductor laser 10. Slow axis S is parallel to the cleavage plane of semiconductor laser 10 and coincides with a width direction of active layer 10a of semiconductor laser 10. Beam shaping lens 20 and condenser lens 30 are disposed on optical axis 51 of light beam 50 emitted from semiconductor laser 10. Semiconductor laser 10, beam shaping lens 20, and condenser lens 30 are disposed in this order.

Beam shaping lens 20 has incident surface 21 and exit surface 22. Incident surface 21 is composed of a cylindrical lens having concave cylindrical surface 23. A generatrix of concave cylindrical surface 23 is parallel to fast axis F. Exit surface 22 has convex cylindrical surface 24. A generatrix of convex cylindrical surface 24 is parallel to fast axis F. Therefore, beam shaping lens 20 has negative refractive power (power) with respect to slow axis S of incoming light beam 50, and does not have refractive power with respect to fast axis F. That is, the refractive power is applied to light beam 50 entering beam shaping lens 20 only along slow axis S. Note that the negative refractive power means an effect in which a light beam spreads when passing through an optical element having the negative refractive power. Examples of an optical element having the negative refractive power include a concave lens.

In light beam 50 emitted from beam shaping lens 20, emission angle θ_{S} along slow axis S and emission angle θ_{F} along fast axis F are equal to each other, and beam diameter D_{S} along slow axis S and beam diameter D_{F} along fast axis F are equal to each other. In other words, light beam 50 emitted from semiconductor laser 10 is converted by beam shaping lens 20 into a divergent light beam having a cross section in which beam diameter D_{S} along slow axis S and beam diameter D_{F} along fast axis F are equal to each other. The cross-sectional shape of the divergent light beam is, for example, circular or rectangular.

The mode in which the aspect ratios of beam diameter D_{S} along slow axis S and beam diameter D_{F} along fast axis F are equal to each other includes a variation within an allowable range in light source device 100. The allowable range of the difference between beam diameter D_{S} along slow axis S and beam diameter D_{F} along fast axis F is within ±10% with respect to beam diameter D_{S} along slow axis S. Further, the mode in which emission angle θ_{S} along slow axis S and emission angle θ_{F} along fast axis F are equal to each other includes a variation within an allowable range in light source device 100. The allowable range of the difference between emission angle θ_{S} along slow axis S and emission angle θF along fast axis F is within ±10% with respect to emission angle θ_{S} along slow axis S.

Condenser lens 30 has incident surface 31 and emission surface 32. Incident surface 31 has convex lens surface 33 that is rotationally symmetric with respect to optical axis 51. Emission surface 32 has convex lens surface 34 that is rotationally symmetric with respect to optical axis 51. Incident light beam 50 is focused on prescribed focusing position P on optical axis 51.

### (Relationship Between Beam Diameter and Spot Diameter)

Here, the relationship between beam diameter D of light beam 50 entering condenser lens 30 and spot diameter W at focusing position P will be described. FIG. 5 shows focusing characteristics according to numerical aperture (NA). In FIG. 5, a solid line shows the focusing characteristics of light beam 50 according to high NA with large beam diameter D. W1 in FIG. 5 is a spot diameter of light beam 50 with high NA. A broken line shows the focusing characteristics of light beam 50 according to low NA with small beam diameter D. W2 in FIG. 5 is a spot diameter of light beam 50 with low NA. As can be seen from FIG. 5, focusing spot W becomes smaller as beam diameter D of the light beam incident on condenser lens 30 becomes larger.

In view of this, beam shaping lens 20 is configured to adjust beam diameter D_{S} along slow axis S to be equal to beam diameter D_{F} along fast axis F as in light source device 100 according to the present disclosure. With this configuration, beam diameter (D_{F}) of light beam 50 emitted from semiconductor laser 10 can be used as efficiently as possible, as compared to a configuration including adjustment of a beam diameter along fast axis F (adjustment in the direction of reducing the emission angle) as in the conventional beam shaping. Therefore, the configuration of the present disclosure can reduce spot diameter W of light source device 100.

### (Adjustment of Focusing Position)

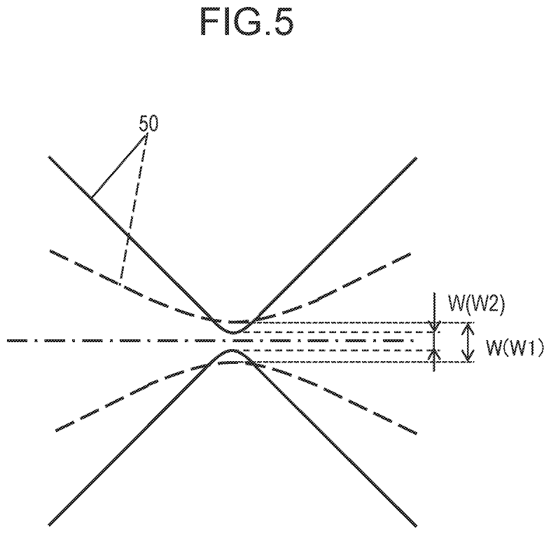

Further, in light source device 100 described above, focusing position P can be adjusted by moving condenser lens 30 in the direction of optical axis 51 so as to change the distance between beam shaping lens 20 and condenser lens 30. FIGS. 6A and 6B are schematic diagrams showing how to adjust focusing position P of light source device 100. FIG. 6A is a diagram of light source device 100 as viewed from slow axis S. FIG. 6B is a diagram of light source device 100 as viewed from fast axis F. In FIGS. 6A and 6B, solid lines show the state before the position of condenser lens 30 is adjusted, and broken lines show the state after the position of condenser lens 30 is adjusted.

In light source device 100, only condenser lens 30 is brought closer to semiconductor laser 10 while keeping the positional relationship between semiconductor laser 10 and beam shaping lens 20. At this time, focusing position P also moves toward semiconductor laser 10. When this phenomenon is used, light source device 100 can set focusing position P at different locations by adjusting the position of condenser lens 30. For example, focusing position P can be adjusted within a range from 100 mm to 200 mm by adjusting the position of condenser lens 30.

Further, the similar adjustment of focusing position P can be achieved by changing the focusing characteristics of condenser lens 30 without changing the position of condenser lens 30. Note that the focusing characteristics include a focal length and numerical aperture of condenser lens 30, for example. In addition, both the position of condenser lens 30 and the focusing characteristics may be adjusted.

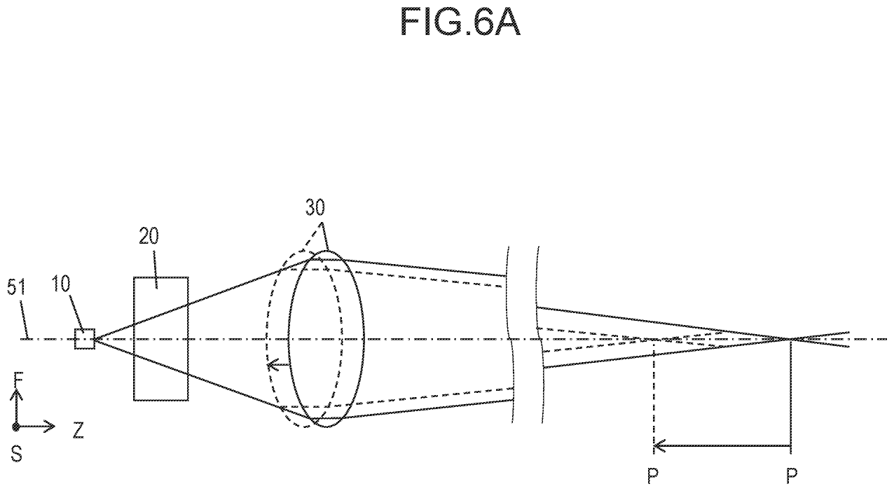

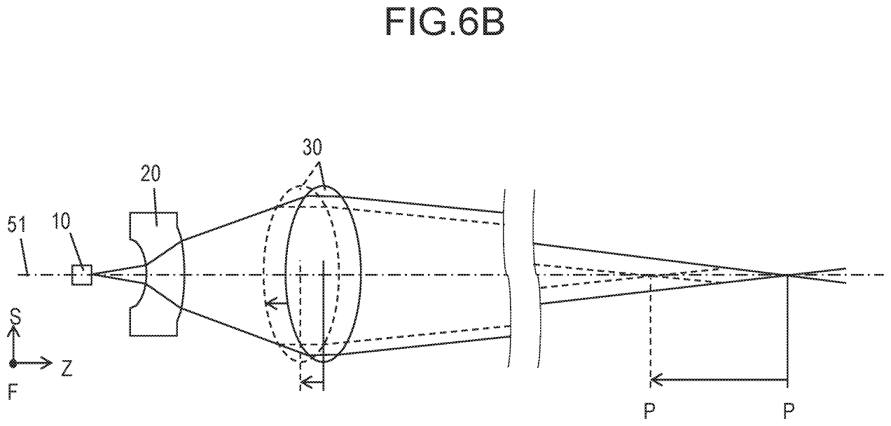

Light source device 100 described above can be used for projection device 200 including optical scanning mirror 210 between semiconductor laser 10 and focusing position P as shown in FIG. 7, and used for fluorescence excitation device 300 including phosphor 310 disposed at focusing position P as shown in FIG. 8. In particular, when used as light source device 100 for a vehicle-mounted head-up display including optical scanning mirror 210 between semiconductor laser 10 and focusing position P, light source device 100 can freely set a distance from the light source to the focusing position (screen). Therefore, one light source device 100 can be used for a wide range of vehicle models.

### (Example of Vehicle-Mounted Head-Up Display)

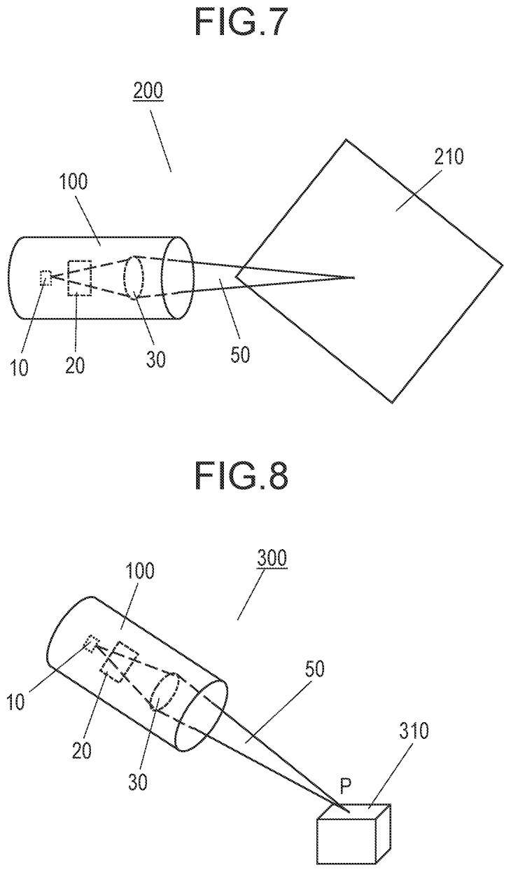

An example of a vehicle-mounted head-up display using light source device 100 will be described below with reference to FIGS. 9 to 11.

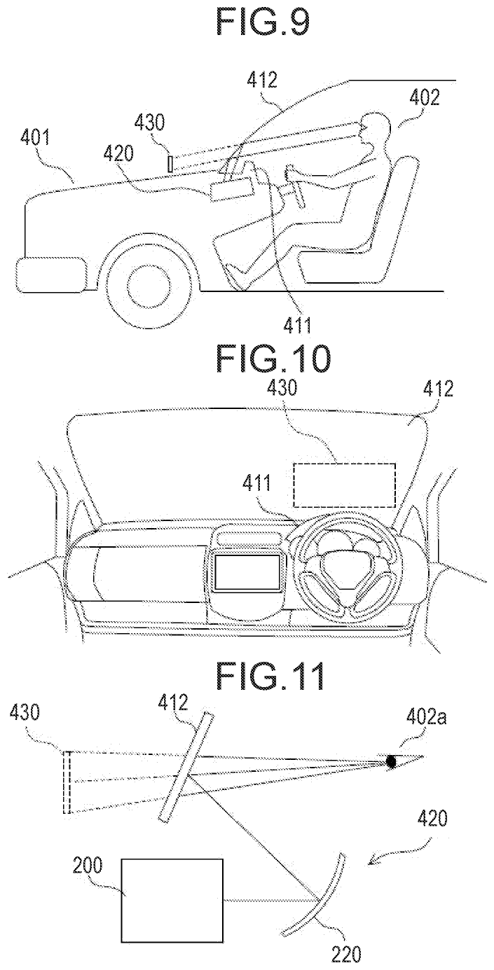

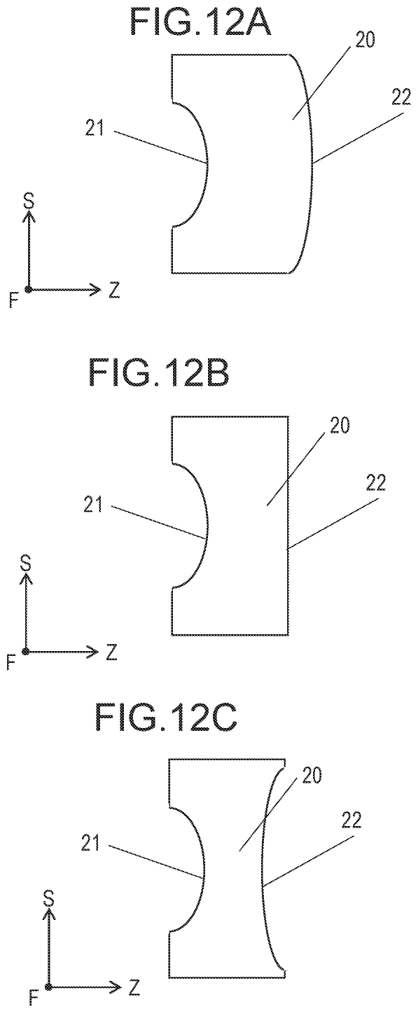

FIG. 9 is a diagram schematically showing the vehicle-mounted head-up display. FIG. 10 is a schematic diagram of the vehicle-mounted head-up display. Further, FIG. 11 is a diagram schematically showing how an image is displayed in the vehicle-mounted head-up display.

In FIG. 9, vehicle-mounted head-up display 420 is mounted on vehicle 401. Virtual image 430 is projected from vehicle-mounted head-up display 420 onto windshield 412, and person 402 sees projected virtual image 430.

Virtual image 430 is projected onto a display surface of windshield 412 in FIG. 10. Note that vehicle-mounted head-up display 420 is mounted on instrument panel 411.

In FIG. 11, vehicle-mounted head-up display 420 includes projection device 200 and mirror 220. Note that projection device 200 includes light source device 100 and optical scanning mirror 210. Light emitted from translucent device 200 is projected onto windshield 412 as virtual image 430 via mirror 220. Virtual image 430 is recognized by eye 402a of the person. Here, since the distance from light source device 100 to windshield 412 serving as a focusing position can be freely set, one light source device 100 can be used for a wide range of vehicle models.

In fluorescence excitation device 300 shown in FIG. 8, a yttrium aluminum garnet (YAG) phosphor can be used as phosphor 310, for example. Examples of other materials usable as phosphor 310 include: a phosphor that produces blue fluorescence represented by a BaMgAl₁₀O₁₇:Eu²⁺ (BAM) phosphor or an Sr₃MgSi₂O₈:Eu²⁺ (SMS) phosphor; a phosphor that produces green or yellow fluorescence (for example, Eu-doped Ca-α-SiAlON or Eu-doped β-SiAlON); and a phosphor that produces red fluorescence (for example, Eu-doped CaAlSiN₃).

Semiconductor laser 10 may be, for example, an AlGaAs/GaAs-based semiconductor laser having a wavelength of 780 nm, an AlGaInP-based semiconductor laser having a wavelength of 650 nm, or a GaN-based semiconductor laser having a wavelength of 420 nm. Further, a semiconductor laser having a wavelength other than the abovementioned wavelengths, for example, a semiconductor laser that emits ultraviolet light, may be used.

Further, beam shaping lens 20 and condenser lens 30 may be formed by using optical glass such as BaK4 or optical plastic.

### [Modifications]

Beam shaping lens 20 used in light source device 100 according to the present disclosure is not limited to the one shown in the perspective view of FIG. 3 and the top view of FIG. 4, and can be modified as described in the following modifications.

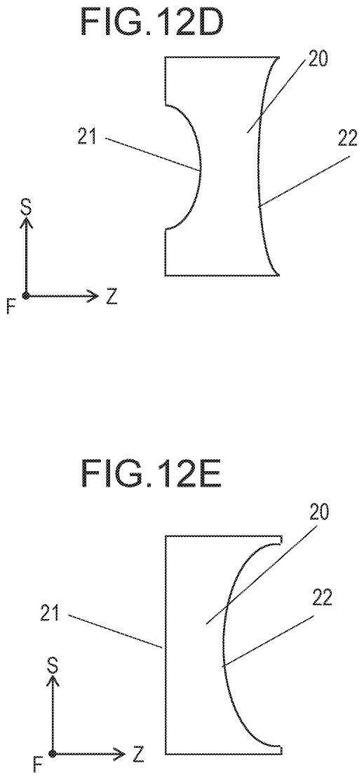

Beam shaping lens 20 according to modifications of light source device 100 of the present disclosure will be described below with reference to FIGS. 12A to 12E.

### [Modification A]

FIG. 12A is a top view of beam shaping lens 20 according to modification A of light source device 100 according to the present disclosure as viewed from fast axis F. That is, emission surface 22 of beam shaping lens 20 according to modification A entirely has a convex cylindrical surface shape. When having such a shape, beam shaping lens 20 can be also given negative refractive power in a slow axis S direction of a light beam entering beam shaping lens 20, thereby being capable of adjusting beam diameter D_{S} along slow axis S to be equal to beam diameter D_{F} along fast axis F.

### [Modification B]

FIG. 12B is a top view of beam shaping lens 20 according to modification B of light source device 100 according to the present disclosure as viewed from fast axis F. That is, emission surface 22 of beam shaping lens 20 according to modification B entirely has a flat shape. When having such a shape, beam shaping lens 20 can be also given negative refractive power in a slow axis S direction of a light beam entering beam shaping lens 20, thereby being capable of adjusting beam diameter D_{S} along slow axis S to be equal to beam diameter D_{F} along fast axis F.

### [Modification C]

FIG. 12C is a top view of beam shaping lens 20 according to modification C of light source device 100 according to the present disclosure as viewed from fast axis F. That is, emission surface 22 of beam shaping lens 20 according to modification C has a concave cylindrical surface shape except for end parts. When having such a shape, beam shaping lens 20 can be also given negative refractive power in a slow axis S direction of a light beam entering beam shaping lens 20, thereby being capable of adjusting beam diameter D_{S} along slow axis S to be equal to beam diameter D_{F} along fast axis F.

### [Modification D]

FIG. 12D is a top view of beam shaping lens 20 according to modification D of light source device 100 according to the present disclosure as viewed from fast axis F. That is, emission surface 22 of beam shaping lens 20 according to modification D entirely has a concave cylindrical surface shape. When having such a shape, beam shaping lens 20 can be also given a negative refractive power in slow axis S direction of a light beam entering beam shaping lens 20, thereby being capable of adjusting beam diameter D_{S} along slow axis S to be equal to beam diameter D_{F} along fast axis F.

### [Modification E]

FIG. 12E is a top view of beam shaping lens 20 according to modification E of light source device 100 according to the present disclosure as viewed from fast axis F. That is, incident surface 21 of beam shaping lens 20 according to modification E entirely has a flat shape. When having such a shape, beam shaping lens 20 can be also given negative refractive power in a slow axis S direction of a light beam entering beam shaping lens 20, thereby being capable of adjusting beam diameter D_{S} along slow axis S to be equal to beam diameter D_{F} along fast axis F.

### INDUSTRIAL APPLICABILITY

The present disclosure has an effect of being capable of reducing a spot diameter of the light source device, and is particularly effective when used for a compact scanning optical system.

### REFERENCE MARKS IN THE DRAWINGS

10 semiconductor laser

11 active layer

20 beam shaping lens

21, 31 incident surface

22, 32 emission surface

23 concave cylindrical surface

24 convex cylindrical surface

30 condenser lens

33 convex lens surface

50 light beam

51 optical axis

100 light source device

200 projection device

210 optical scanning mirror

300 fluorescence excitation device

310 phosphor

401 vehicle

402 person

402a eye

411 instrument panel

412 windshield

420 vehicle-mounted head-up display

430 virtual image

F fast axis

P focusing position

S slow axis

1. A light source device comprising:
a semiconductor laser;
a beam shaping lens that adjusts an aspect ratio of a light beam emitted from the semiconductor laser and transmits the light beam; and
a condenser lens that focuses the light beam passing through the beam shaping lens on a prescribed focusing position, wherein the beam shaping lens is a cylindrical lens having negative power with respect to a slow axis direction of the light beam.

2. The light source device according to claim 1, wherein the prescribed focusing position is determined by a distance between the cylindrical lens and the condenser lens.

3. The light source device according to claim 1, wherein the prescribed focusing position is determined by focusing characteristics of the condenser lens.

4. A projection device comprising:
the light source device according to claim 1; and
an optical scanning minor disposed at the prescribed focusing position.

5. A fluorescence excitation device comprising:
the light source device according to claim 1; and
a phosphor disposed at the prescribed focusing position.
